(19) United States
(12) Patent Application Publication
(10) Pub. No.: US 2017/0372337 A1
(43) Pub. Date: Dec. 28, 2017

(54) EVALUATING AND COMPARING PREDICTED CUSTOMER PURCHASE BEHAVIOR FOR EDUCATIONAL TECHNOLOGY PRODUCTS

(71) Applicant: LinkedIn Corporation, Mountain View, CA (US)

(72) Inventors: Zhaoying Han, Mountain View, CA (US); Coleman Patrick King, III, Brooklyn, NY (US); Yiying Cheng, Mountain View, CA (US); Juan Wang, Los Altos, CA (US)

(73) Assignee: LinkedIn Corporation, Mountain View, CA (US)

(21) Appl. No.: 15/195,870

(22) Filed: Jun. 28, 2016

(51) Int. Cl. G06Q 30/02; H04L 12/24; H04L 12/26; H04L 29/08

(52) U.S. Cl. CPC G06Q 30/0202; H04L 67/02; H04L 41/22; H04L 43/045; H04L 43/0876

(57) ABSTRACT

The disclosed embodiments provide a system for processing data. During operation, the system obtains a set of overall scores representing predicted purchase behaviors of a set of customers with an educational technology product. Next, the system displays a graphical user interface (GUI) comprising a customer prioritization chart for the educational technology product. The system then displays representations of the overall scores in the customer prioritization chart. Finally, the system displays, in the GUI, the set of overall scores and a breakdown of the overall scores into a set of sub-scores that characterize different components of the overall scores.

### RELATED APPLICATION

The subject matter of this application is related to the subject matter in a co-pending non-provisional application by inventors Zhaoying Han, Coleman Patrick King III, Wei Di and Juan Wang and filed on the same day as the instant application, entitled “Predicting Customer Purchase Behavior for Educational Technology Products,” having serial number ______, and filing date ______ (Attorney Docket No. LI-P2014.LNK.US).

### BACKGROUND

### Field

The disclosed embodiments relate to techniques for managing sales activities. More specifically, the disclosed embodiments relate to techniques for evaluating and comparing predicted customer purchase behavior for educational technology products.

### Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an exemplary screenshot in accordance with the disclosed embodiments.

FIG. 4 shows a flowchart illustrating the processing of data in accordance with the disclosed embodiments.

FIG. 5 shows a flowchart illustrating the process of providing a graphical user interface (GUI) on a computer system in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

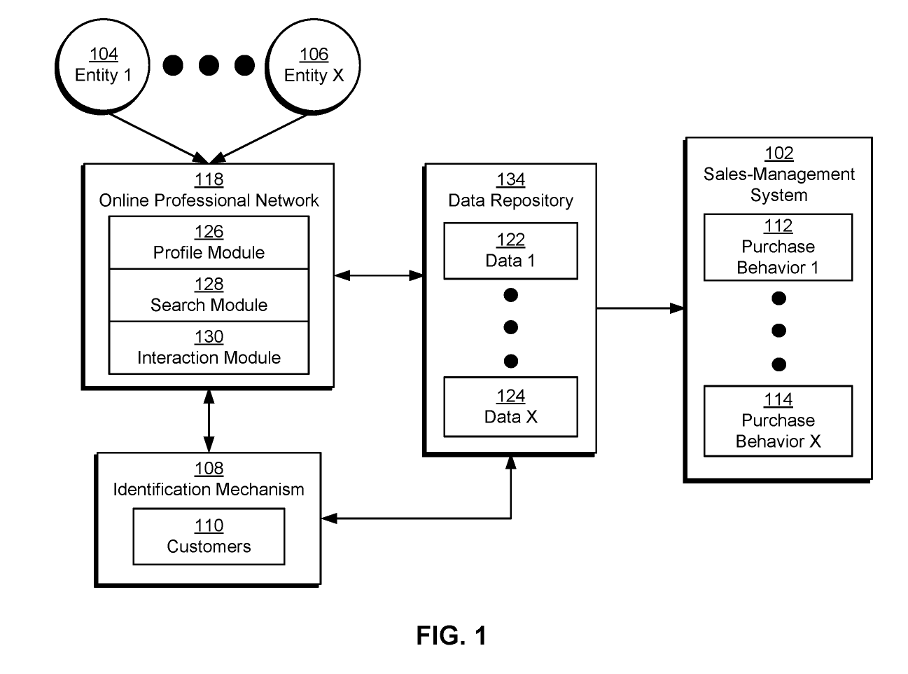

The disclosed embodiments provide a method, apparatus, and system for processing data. More specifically, the disclosed embodiments provide a method, apparatus, and system for predicting, evaluating, and comparing predicted customer purchase behavior for educational technology products. As shown in FIG. 1, customers 110 may be members of a social network, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use online professional network 118 to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills. Profile module 126 may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, post updates or messages, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or newsfeed that provides the latest postings, articles, and/or updates from the entities' connections and/or groups to the entities. Similarly, the online professional network may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

The entities may also include customers 110 that purchase products through online professional network 118. For example, customers 110 may include individuals and/or organizations with profiles on the online professional network and/or sales accounts with sales professionals that operate through the online professional network. As a result, customers 110 may use online professional network 118 to interact with professional connections, list and apply for jobs, establish professional brands, purchase or use products offered through the online professional network, and/or conduct other activities in a professional and/or business context.

Customers 110 may also be targeted for marketing or sales activities by other entities in online professional network 118. For example, customers 110 may include companies that purchase educational technology products and/or solutions that are offered by the online professional network. In another example, customers 110 may include individuals and/or companies that are targeted by marketing and/or sales professionals through the online professional network.

As shown in FIG. 1, customers 110 may be identified by an identification mechanism 108 using data from data repository 134 and/or online professional network 118. For example, identification mechanism 108 may identify customers 110 by matching profile data, group memberships, industries, skills, customer relationship data, and/or other data for customers 110 to keywords related to products that may be of interest to the customers. Identification mechanism 108 may also identify customers 110 as individuals and/or companies that have sales accounts with online professional network 118 and/or products offered by or through the online professional network. As a result, customers 110 may include entities that have purchased products through and/or within online professional network 118, as well as entities that have not yet purchased but may be interested in products offered through and/or within online professional network 118.

Identification mechanism 108 may also match customers 110 to products using different sets of criteria. For example, identification mechanism 108 may match customers in recruiting roles to recruiting solutions, customers in sales roles to sales solutions, customers in marketing roles to marketing solutions, customers in learning and development roles to educational technology products, and customers in advertising roles to advertising solutions. If different variations of a solution are available, identification mechanism 108 may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, customers 110 may include all entities in online professional network 118, which may be targeted with products such as “premium” subscriptions or memberships with online professional network 118.

After customers 110 are identified, they may be targeted by one or more sales professionals with relevant products. For example, the sales professionals may engage customers 110 with recruiting, marketing, sales, and/or advertising solutions that may be of interest to the customers. After a sales deal is closed with a given customer, a sales professional may follow up with the customer to improve the customer lifetime value (CLV) and retention of the customer.

To facilitate prioritization of sales activities with the customers, identification mechanism 108 and/or a sales-management system 102 may predict a purchase behavior (e.g., purchase behavior 1 112, purchase behavior x 114) of each customer with respect to an educational technology product (e.g., e-learning product) offered by or within online professional network 118. The purchase behaviors may include an overall score representing the customers' likelihood of purchasing the educational technology product, a number of sub-scores that characterize different components of the overall scores, and/or a potential spending of the customer with the educational technology product. As described in further detail below, sales-management system 102 may predict the purchase behaviors using one or more statistical models and a set of features for the customer. In turn, the predicted purchase behavior may facilitate sales and/or business operations such as territory planning, customer prioritization, marketing, and/or total addressable market (TAM) analysis.

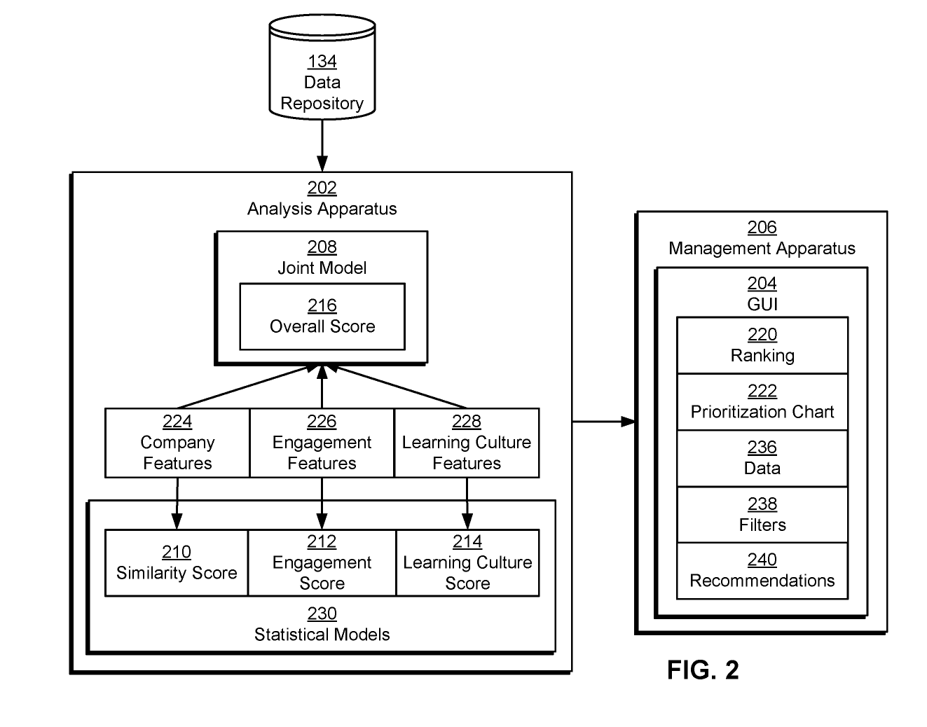

FIG. 2 shows a system for processing data in accordance with the disclosed embodiments. More specifically, FIG. 2 shows a system for predicting, evaluating, and comparing predicted customer purchase behavior for a set of customers of an educational technology product, such as sales-management system 102 of FIG. 1. As shown in FIG. 2, the system includes an analysis apparatus 202 and a management apparatus 206. Each of these components is described in further detail below.

Analysis apparatus 202 may predict purchase behaviors for a number of customers of a product, such as companies that may potentially purchase an educational technology product offered through online professional network 118 of FIG. 1. Each customer may be a current or prospective customer that is identified using data from data repository 134. Analysis apparatus 202 may also use data from data repository 134 to generate a set of features for the customer, including one or more company features 224, one or more engagement features 226, and one or more learning culture features 228. For example, analysis apparatus 202 may use one or more queries or operations to obtain the features directly from data repository 134, extract one or more features from the queried data, apply transformations to the features, and/or aggregate the queried data into one or more features.

Company features 224 may include attributes and/or metrics associated with a customer that is a company. For example, the company features may include demographic attributes such as a location, an industry, an age, and/or a size (e.g., small business, medium/enterprise, global/large, number of employees, etc.) of the company. The company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. The company features may further include a measure of dispersion in the company, such as a number of unique regions (e.g., metropolitan areas, counties, cities, states, countries, etc.) to which the employees and/or members of the online professional network from the company belong.

Company features 224 may additionally include metrics related to key market segments for consuming educational technology products, such as information technology (IT) professionals, software developers, data scientists, creative roles (e.g., designers, artistic directors, artists, etc.), managers, and/or decision makers (e.g., vice presidents, directors, executives, owners, etc.). These metrics may include, for example, the number of employees and/or online professional network members at the company in each market segment and/or the number of employees and/or online professional network members that belong only to a single market segment. Generally, key market segments may include users or roles that are related or relevant to educational content, tools, or features provided with the educational technology product.

Engagement features 226 may represent the customer's level of engagement with and/or presence on the online professional network. For example, the engagement features may include the number of members of the online professional network who work at the company, the number of online professional network members at the company with connections to employees of the online professional network, the number of connections among employees in the company, and/or the number of followers of the company in the online professional network. The engagement features may also track visits to the online professional network from employees of the company, such as the number of employees at the company who have visited the online professional network over a recent period (e.g., the last 30 days) and/or the same number of visitors divided by the total number of online professional network members at the company.

Engagement features 226 may also include the customer's engagement with products offered by or through the online professional network. For example, the engagement features may include a social selling index (SSI) score that measures the level of sales activity at the company, an interest score that estimates the company's likelihood of purchasing another product offered through the online professional network (e.g., recruiting solution, sales solution, marketing solution, advertising solution, etc.), the company's spending with the other product, the company's level of activity or success with the other product (e.g., a number of hires impacted by a recruiting solution in the last 12 months), and/or the company's status as a customer or non-customer with the other product.

Learning culture features 228 may characterize the level of learning culture at a customer company. For example, the learning culture features may describe the connectedness of the company with e-learning companies using metrics such as the number of online professional network connections between employees of the company and e-learning companies, the same number of connections divided by the total number of online professional network members at the company, the number of connections between the company's employees and e-learning sales professionals, and/or the number of sales professionals at the company with connections to e-learning companies. The learning culture features may also include the number of people at the company who follow an e-learning company (e.g., in the online professional network), the same number of followers divided by the total number of online professional network members at the company, the number of company employees with e-learning certificates, and/or the same number of employees divided by the total number of employees and/or online professional network members at the company. The learning culture features may further identify the presence or absence of learning decision makers at the company (e.g., people with online professional network profiles related to learning or development), the number of learning decision makers at the company, and/or whether a learning decision maker has recently joined the company (e.g., in the last six months). Finally, the learning culture features may identify the number of online professional network members at the company with skills listed in their profiles and/or the same number of members divided by the total number of online professional network members at the company.

After company features 224, engagement features 226, and learning culture features 228 are obtained from data repository 134, analysis apparatus 202 may modify some or all of the features. First, the analysis apparatus may apply imputations that add default values, such as zero numeric values or median values, to features with missing values. Second, the analysis apparatus may “bucketize” numeric values for some features (e.g., number of employees) into ranges of values and/or a smaller set of possible values. Third, the analysis apparatus may apply, to one or more subsets of features, a log transformation that reduces skew in numeric values and/or a binary transformation that converts zero and positive numeric values to respective Boolean values of zero and one. Fourth, the analysis apparatus may normalize scores to be within a range (e.g., between 0 and 10), verify that feature ratios are within the range of 0 and 1, and perform other transformations of the features. In general, such preprocessing and/or modification of features by the analysis apparatus may be performed and/or adapted based on configuration files and/or a central feature list.

Next, analysis apparatus 202 may apply a joint model 208 to company features 224, engagement features 226, and learning culture features 228 to calculate, for each customer, an overall score 216 representing the predicted purchase behavior of the customer with the educational technology product. A higher overall score may represent a higher likelihood of purchasing the educational technology product, and a lower overall score may represent a lower likelihood of purchasing the educational technology product.

Joint model 208 may be an ensemble model that includes one or more gradient boosted trees, random forest models, and/or other types of statistical models. The joint model may be trained using a positive class of customers of the educational technology product and a negative class of companies that tried but did not purchase the educational technology product (i.e., non-adopters). The customers and non-adopters may be identified using sales and/or customer relationship management (CRM) data for a set of companies. If a training data set for a particular class (e.g., non-adopters) is significantly smaller than the training data set for the other class (e.g., customers), the smaller data set may be supplemented with data from companies that have been identified by a prediction technique as likely non-adopters of the educational technology product. The positive class and negative class may be labeled with different values (e.g., 1 for companies that became customers of the educational technology product and 0 for companies that did not adopt the educational technology product), and the labels may be provided with features of the corresponding companies as training data to multiple statistical models in the joint model. Multiple values of the overall score outputted by the statistical models may then be averaged, summed, and/or otherwise aggregated to obtain a final value for the overall score. Because the final value includes output from multiple statistical and/or ensemble models, bias and variance in the joint model may be reduced over techniques that perform scoring using individual statistical models.

Analysis apparatus 202 may additionally use different subsets of the features and a number of additional statistical models 230 to calculate a set of sub-scores that characterize different components of overall score 216. For example, analysis apparatus 202 may use three different random forest models, gradient boosting trees, and/or ensemble models (e.g., combinations of random forest models and gradient boosting trees) to calculate a similarity score 210, an engagement score 212, and a learning culture score 214 as three sub-scores for the overall score.

Similarity score 210 may represent a demographic similarity of the customer to existing customers of the educational technology product. As a result, the similarity score may be calculated primarily or solely using company features 224, with a high similarity score indicating strong similarity to one or more existing customers of the educational technology product and a low similarity score indicating a lack of similarity to existing customers of the educational technology product. Multiple values of similarity score 210 may optionally be calculated to assess the customer's similarity with existing customers from different industries, existing customers of different sizes, and/or other categories of existing customers.

Engagement score 212 may characterize the similarity in engagement with the online professional network between the customer and the existing customers. The engagement score may thus be calculated primarily or solely using engagement features 226, with a high engagement score representing a high level of similarity in online professional network engagement between the customer and the existing customers and a low engagement score representing a low level of similarity in online professional network engagement between the customer and existing customers.

Learning culture score 214 may represent the similarity in learning culture between the customer and the existing customers. In turn, the learning culture score may be calculated primarily or solely using learning culture features 228, with a high learning culture score representing significant similarity in learning culture between the customer and existing customers and a low learning culture score representing a low level of similarity in learning culture between the customer and existing customers.

More specifically, overall score 216 may be represented as a weighted combination of similarity score 210, engagement score 212, and learning culture score 214 for a given customer. Weights in the weighted combination may reflect the relative importance of the corresponding scores in contributing to the overall score. For example, a maximum overall score of 100 may be composed of a maximum similarity score of 50, a maximum engagement score of 30, and a maximum learning culture score of 20. As a result, the individual scores may be scaled so that the similarity score contributes 50% to the overall score, the engagement score contributes 30% to the overall score, and the learning culture score contributes 20% to the overall score.

Moreover, the sub-scores may be iteratively adjusted until the sum of the sub-scores equals overall score 216. As described above, each sub-score may be calculated from a subset of features used in producing the overall score. As a result, similarity score 210, engagement score 212, and learning culture score 214 produced by statistical models 230 may sum to a value that is less than or greater than the overall score. To compensate for the difference, the sub-scores may be calibrated to reflect the corresponding weighted contributions to the overall score and to sum to the overall score.

Similarity score 210, engagement score 212, learning culture score 214, and overall score 216 may then be displayed within a GUI 204 by management apparatus 206, along with user-interface elements in GUI 204 for searching, sorting, filtering, updating, and/or exporting the information. First, the management apparatus may display a ranking 220 of customers sorted by one or more attributes within GUI 204. For example, the management apparatus may include a pre-specified number of potential customers with the highest overall scores in the ranking.

Second, management apparatus 206 may display a prioritization chart 222 containing representations of overall score 216 and/or other metrics related to predicted purchase behaviors for the customers. The prioritization chart may be used to identify customers with high likelihood of purchasing the educational technology product, compare the predicted customer purchase behaviors across different types or sets of clients, and/or manage sales or marketing activities based on the predicted customer purchase behaviors.

Third, management apparatus 206 may display data 236 associated with the customers and predicted purchase behaviors. For example, the data may include account IDs, account names, industries, numbers of employees, and/or other information related to the customers.

To facilitate analysis using ranking 220, prioritization chart 222, and/or data 236, management apparatus 206 may provide one or more filters 238. For example, the management apparatus may display filters for account owner, manager, potential spending, and/or one or more scores. After one or more filters are specified through GUI 204, the management apparatus may update the displayed ranking, prioritization chart, and/or data to reflect the filters.

Finally, management apparatus 206 may provide one or more recommendations 240 based on the output from analysis apparatus 202. First, management apparatus 206 may recommend targeting of customers with different levels of potential spending 218 and/or values or ranges of overall score 216 with different acquisition channels and/or sales strategies. The management apparatus may further tailor the strategies and/or acquisition channels according to the values of the overall score and/or sub-scores. For example, the management apparatus may suggest sales or marketing strategies that focus on e-learning with customers that have high values of learning culture score 214. In another example, the management apparatus may use similarity score 210 to identify groups of similar companies and/or tailor sales or marketing strategies to each group.

Second, management apparatus 206 may recommend assignments of customers to sales and/or marketing professionals, such that customers with the highest scores and/or potential spending are targeted by the most effective sales and/or marketing professionals. The assignments may also be made so that customers in different market segments (e.g., industries, sizes, locations, etc.) and/or groups of similar customers are assigned to sales and/or marketing professionals with expertise in marketing or selling products to those segments or groups. Consequently, the system of FIG. 2 may improve or automate the use of sales or marketing technology by allowing territory planning and/or other sales or marketing activities to be conducted based on predicted customer purchase behavior with the educational technology product and/or other relevant customer attributes.

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, company features 224, engagement features 226, and learning culture features 228 may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness. Data repository 134 may further include data from external systems, such as CRM and/or sales-management platforms.

Finally, statistical models 230 and/or joint model 208 may be implemented using different techniques and/or used to produce output in different ways. For example, one or more statistical models 230 and/or portions of the joint model may be implemented using artificial neural networks, Bayesian networks, support vector machines, clustering techniques, regression models, random forests, gradient boosted trees, bootstrap aggregating, and/or other types of machine learning techniques. Moreover, different groupings of customers and/or scores may be used with different versions of the statistical models and/or joint model. For example, different versions of the joint model and/or statistical models may be used to estimate potential spending and scores for different types of the educational technology product and/or customers in different market segments.

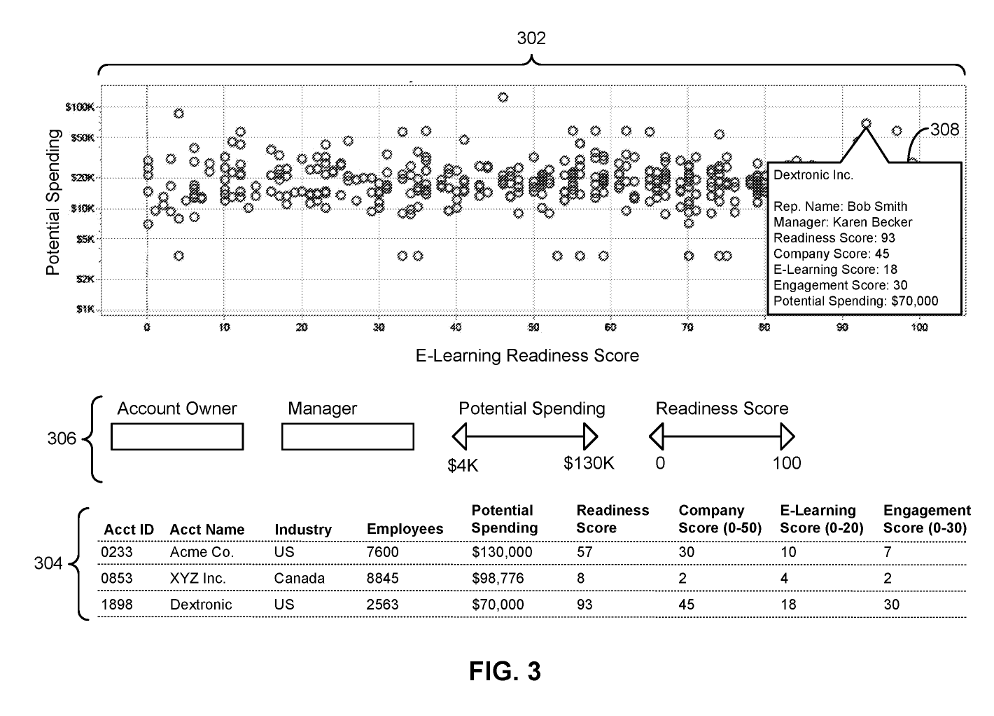

FIG. 3 shows an exemplary screenshot in accordance with the disclosed embodiments. More specifically, FIG. 3 shows a screenshot of a GUI, such as GUI 204 of FIG. 2. As discussed above, the GUI may be used to evaluate and compare predicted customer purchase behavior for an educational technology product, such as an e-learning product that is offered or accessed through an online professional network.

As shown in FIG. 3, the GUI includes a customer prioritization chart 302 for the educational technology product. The x-axis of the chart may represent an overall score (i.e., “E-Learning Readiness Score”) indicating the predicted purchase behaviors of a set of potential customers of the educational technology product, and the y-axis of the chart may represent a potential spending of the customers with the educational technology product. Within the chart, each customer is represented by a circle; the horizontal position of the circle may represent the customer's overall score, and the vertical position of the circle may represent the customer's potential spending.

The GUI of FIG. 3 also includes a table 304 of data for the customers. Columns of the table may identify an account ID (i.e., “Acct ID”), account name (i.e., “Acct Name”), industry, and/or number of employees of each customer. The columns may additionally specify the potential spending, the overall score (i.e., “Readiness Score”), and a breakdown of the overall score into sub-scores that include a similarity score (i.e., “Company Score”), a learning culture score (i.e., “E-Learning Score”), and an engagement score for the customer.

Rows of table 304 may be sorted by increasing or decreasing values in the columns of the table. As shown in FIG. 3, the rows of the table are sorted in decreasing order of potential spending. A user may click, double-click, and/or otherwise interact with the heading of a given column to sort the rows by increasing and/or decreasing values in the column.

Different views of data in chart 302 and table 304 may be generated by applying one or more filters 306 to the data. Filters 306 may include an account owner, manager, a range of potential spending values, and a range of overall scores. After a filter is specified in the corresponding user-interface element, the chart and table may be updated to contain data that matches the filter. For example, the range of potential spending may be narrowed to remove customers that fall outside of the range from the chart and table.

Chart 302, table 34, and/or other parts of the GUI may further be updated based on a position of a cursor in the GUI. For example, chart 302 may include a user-interface element 308 that is adjacent to a representation of a customer (i.e., a circle) in the chart. User-interface element 308 may be displayed when the cursor is positioned over the circle. Data in the user-interface element may include a representative name (i.e., “Bob Smith”), a manager (i.e., “Karen Becker”), an overall score (i.e., “93”), a company score (i.e., “45”), a learning culture score (i.e., “18”), an engagement score (i.e., “30”), and a potential spending (i.e., “$70,000”). As the cursor is moved over other circles in the chart, the position of the user-interface element may shift to be adjacent to the circle over which the cursor is currently positioned, and values in the user-interface element may be updated to reflect data associated with the corresponding renewal opportunity.

Chart 302, table 304, and/or user-interface element 308 may be used to identify and compare predicted purchase behaviors across potential customers of the educational technology product. For example, the upper right quadrant of the chart may be used to identify customers with high overall scores and high potential spending for targeting by experienced sales and/or marketing professionals. In another example, the upper left quadrant of the chart and data in the table and/or user-interface element may be used to select individual customers with high potential spending and lower overall scores for targeting by the sales and/or marketing professionals when high values of one or more sub-scores indicate that the customers may be receptive to purchasing the educational technology product.

Those skilled in the art will appreciate that chart 302, table 304, and/or user-interface element 308 may include other types and/or representations of information. For example, potential spending, overall scores, sub-scores, and/or other attributes of customers in the chart may be distinguished by shading, highlighting, line types, darkness, shape, size, and/or other visual attributes. Axes of the chart may also represent other metrics and/or dimensions related to the customers and/or the predicted purchase behaviors of the customers. Chart 302 may further be a line chart, a pie chart, a bar chart, and/or other visualization of the predicted purchase behaviors of the customers. In a second example, table 304 and/or user-interface element 308 may include different types and/or representations of information related to sales and/or marketing activities with the customers.

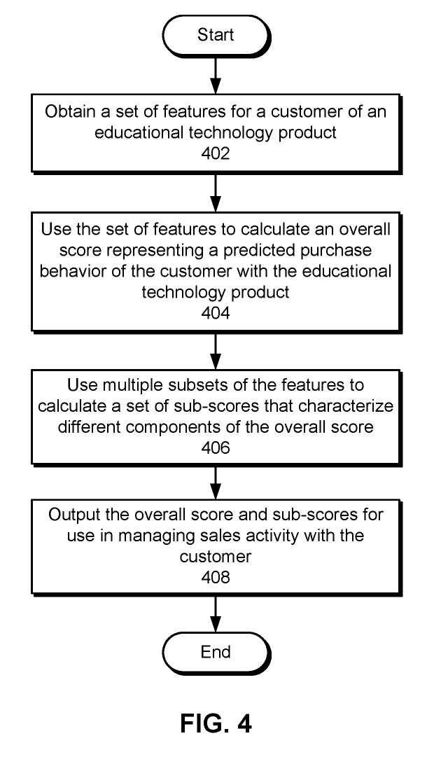

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of features for a customer of an educational technology product is obtained (operation 402). For example, the features may include company features (if the customer is a company), such as a company characteristic (e.g., size, location, industry, etc.), a potential spending with other products (e.g., recruiting solutions, marketing solutions, sales solutions, advertising solutions, etc.), and/or a company statistic (e.g., number of employees in key market segments, number of recruiters, etc.). The features may also include engagement features related to the company's engagement with an online professional network and/or social network, such as the number of visits to the online professional network from the company, the number of members of the online professional network in the company, the number of internal or external connections of the members, and/or the previous purchase behavior of the customer with one or more other products associated with the online professional network. The features may further include learning culture features related to the amount of learning culture at the company, such as a connectedness to educational technology entities in an online professional network, a number of company employees with skills listed on the online professional network, a number of learning decision makers at the company, and/or a number of e-learning certificates earned by the employees.

Next, the set of features is used to calculate an overall score representing a predicted purchase behavior of the customer with the educational technology product (operation 404). For example, the features may be used as input to a joint model that includes one or more random forests and/or gradient-boosted trees to produce multiple values of the overall score and potential spending. The multiple values may then be summed, averaged, and/or otherwise combined into final values of the overall score and potential spending.

Multiple subsets of the features are also used to calculate a set of sub-scores that characterize different components of the overall score (operation 406). For example, the sub-scores may include a similarity score representing the demographic similarity of the customer to existing customers of the educational technology product, an engagement score representing the similarity in engagement with the online professional network between the customer and existing customers, and/or a learning culture score representing the similarity in learning culture between the customer and existing customers. The similarity score may be calculated using the company features, the engagement score may be calculated using the engagement features, and the learning culture score may be calculated using the learning culture features. Each subset of features may be provided as input to a different statistical model or ensemble model, and the corresponding sub-score may be obtained as output from the statistical model or ensemble model. The sub-scores may then be iteratively adjusted until the sum of the sub-scores equals the overall score and the sub-scores are weighted to contribute the corresponding amounts to the overall score.

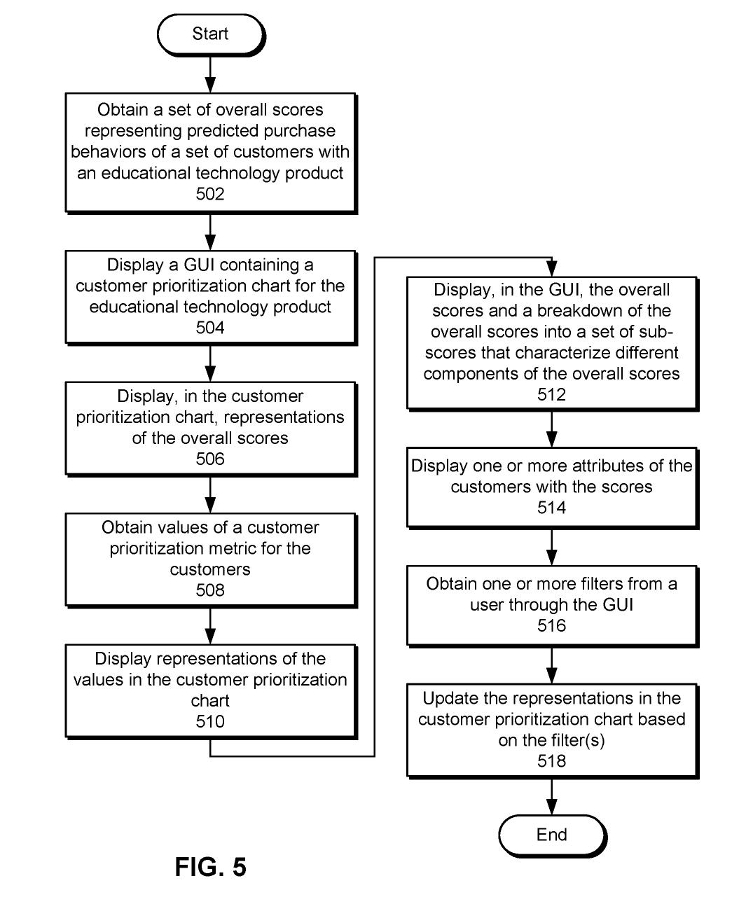

Finally, the overall score and sub-scores are outputted for use in managing sales activity with the customer (operation 408). For example, the scores may be displayed within a GUI, as described in further detail below with respect to FIG. 5. The outputted data may then be used to assign sales and/or marketing professionals to customers, prioritize targeting of the customers, customize sales and/or marketing strategies to the customers, and/or otherwise manage sales and/or marketing activities according to the predicted purchase behaviors of the customers.

FIG. 5 shows a flowchart illustrating the process of providing a graphical user interface (GUI) on a computer system in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a set of overall scores representing predicted purchase behaviors of a set of customers with an educational technology product is obtained (operation 502), as described above with respect to FIG. 4. Next, a GUI containing a customer prioritization chart for the educational technology product is displayed (operation 504), and representations of the overall scores are displayed in the customer prioritization chart (operation 506). For example, the overall scores may be displayed using points, lines, shapes, bars, pie slices, and/or other graphical objects in the chart.

Values of a customer prioritization metric are also obtained for the customers (operation 508), and representations of the values are displayed in the customer prioritization chart (operation 510). For example, the customer prioritization metric may include a potential spending and/or other metric associated with purchasing of the educational technology product. The overall scores may be represented by one axis of the chart, and the customer prioritization metric may be represented by the other axis of the chart.

The GUI is additionally used to display the overall scores and a breakdown of the overall scores into a set of sub-scores that characterize different components of the overall scores (operation 512). For example, the overall scores and/or sub-scores may be displayed in the chart, a table, and/or an overlay element in the GUI. One or more attributes of the customers may also be displayed with the scores (operation 514). For example, the attributes may include account IDs, account names, industries, numbers of employees, and/or other information related to the customers.

Finally, one or more filters are obtained from a user through the GUI (operation 516), and the representations in the customer prioritization chart are updated based on the filter(s) (operation 518). The filters may include an account owner, manager, overall score range, and/or range of values for the customer prioritization metric. After the filters are specified, the chart and/or other data displayed in the GUI may be updated with data from customers that match the filters.

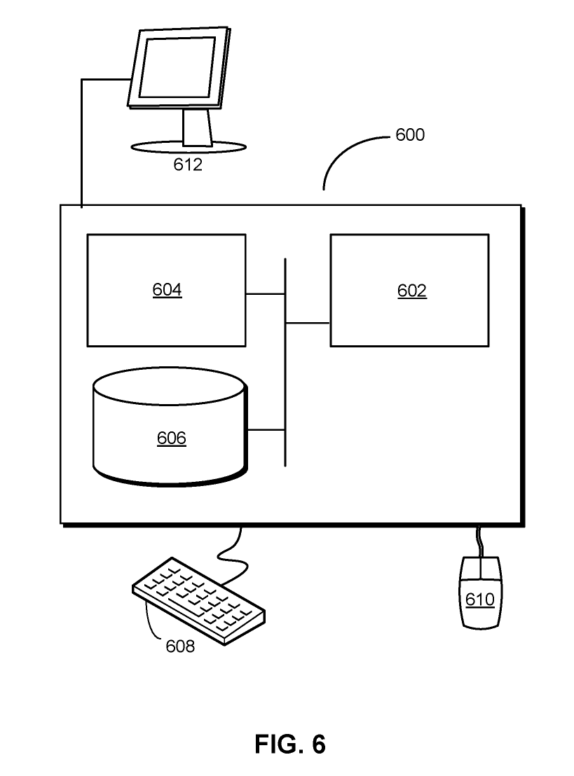

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system may include an analysis apparatus and a management apparatus, one or both of which may alternatively be termed or implemented as a module, mechanism, or other type of system component. The analysis apparatus may obtain a set of features for a customer of an educational technology product. Next, the analysis apparatus may use the set of features to calculate an overall score representing a predicted purchase behavior of the customer with the educational technology product. The analysis apparatus may then use multiple subsets of the features to calculate a set of sub-scores that characterize different components of the overall score.

The management apparatus may output the overall score and the sub-scores for use in managing sales activity with the customer. The management apparatus may also display a graphical user interface (GUI) containing a customer prioritization chart for the educational technology product and display representations of the overall scores in the customer prioritization chart.

In addition, one or more components of computer system 600 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that predicts, evaluates, and compares predicted purchase behavior for a set of remote customers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of overall scores representing predicted purchase behaviors of a set of customers with an educational technology product;
displaying, by a computer system, a graphical user interface (GUI) comprising a customer prioritization chart for the educational technology product;
displaying representations of the overall scores in the customer prioritization chart; and
displaying, in the GUI, the set of overall scores and a breakdown of the overall scores into a set of sub-scores that characterize different components of the overall scores.

2. The method of claim 1, further comprising:
obtaining, for the set of customers, a set of values of a customer prioritization metric; and
displaying representations of the set of values in the customer prioritization chart.

3. The method of claim 2, wherein the chart comprises:
a first axis representing the overall scores; and
a second axis representing the customer prioritization metric.

4. The method of claim 2, wherein the customer prioritization metric comprises a potential spending.

5. The method of claim 1, wherein the sub-scores comprise:
a similarity score representing a similarity of a customer to existing customers of the educational technology product;
an engagement score representing a level of engagement of the customer with an online professional network; and
a learning culture score representing an amount of learning culture associated with the customer.

6. The method of claim 1, further comprising:
displaying, in the GUI, one or more attributes of the customers with the set of overall scores and the breakdown of the overall scores into the sub-scores.

7. The method of claim 6, wherein the one or more attributes comprise at least one of:
an account ID;
an account name;
an industry; and
a number of employees.

8. The method of claim 1, further comprising:
obtaining one or more filters from a user through the GUI; and
updating the representations in the customer prioritization chart based on the one or more filters.

9. The method of claim 8, wherein the one or more filters comprise at least one of:
an account owner;
a manager;
an overall score range; and
a range of values for a customer prioritization metric.

10. The method of claim 1, wherein obtaining the set of overall scores comprises:
inputting a set of features for a customer of the educational technology product into a joint model;
using the joint model to calculate multiple values of the overall score; and
combining the multiple values into a final value of the overall score.

11. The method of claim 10, wherein the one or more statistical models comprise:
a random forest; and
a gradient-boosted tree.

12. An apparatus, comprising:
one or more processors; and
memory storing instructions that, when executed by the one or more processors, cause the apparatus to:
obtain a set of overall scores representing predicted purchase behaviors of a set of customers with an educational technology product;
display a graphical user interface (GUI) comprising a customer prioritization chart for the educational technology product;
display representations of the overall scores in the customer prioritization chart; and
display, in the GUI, the set of overall scores and a breakdown of the overall scores into a set of sub-scores that characterize different components of the overall scores.

13. The apparatus of claim 12, wherein the memory further stores instructions that, when executed by the one or more processors, cause the apparatus to:
obtain, for the set of customers, a set of values of a customer prioritization metric; and
display representations of the set of values in the customer prioritization chart.

14. The apparatus of claim 13, wherein the chart comprises:
a first axis representing the overall scores; and
a second axis representing the customer prioritization metric.

15. The apparatus of claim 13, wherein the customer prioritization metric comprises a potential spending.

16. The apparatus of claim 12, wherein the memory further stores instructions that, when executed by the one or more processors, cause the apparatus to:
display, in the GUI, one or more attributes of the customers with the set of overall scores and the breakdown of the overall scores into the sub-scores.

17. The apparatus of claim 12, wherein the sub-scores comprise:
a similarity score representing a similarity of a customer to existing customers of the educational technology product;
an engagement score representing a level of engagement of the customer with an online professional network; and
a learning culture score representing an amount of learning culture associated with the customer.

18. The apparatus of claim 12, wherein obtaining the set of overall scores comprises:
inputting a set of features for a customer of the educational technology product into a joint model;
using the joint model to calculate multiple values of the overall score; and
combining the multiple values into a final value of the overall score.

19. A system, comprising:
an analysis module comprising a non-transitory computer-readable medium storing instructions that, when executed, cause the system to obtain a set of overall scores representing predicted purchase behaviors of a set of customers with an educational technology product; and
a management module comprising a non-transitory computer-readable medium storing instructions that, when executed, cause the system to:
display a graphical user interface (GUI) comprising a customer prioritization chart for the educational technology product;
display representations of the overall scores in the customer prioritization chart; and
display, in the GUI, the set of overall scores and a breakdown of the overall scores into a set of sub-scores that characterize different components of the overall scores.

20. The system of claim 19, wherein the non-transitory computer-readable medium of the management module further stores instructions that, when executed, cause the system to:
obtain, for the set of customers, a set of values of a customer prioritization metric; and
display representations of the set of values in the customer prioritization chart.
